(19) United States
(12) Patent Application Publication
(10) Pub. No.: US 2023/0348822 A1
(43) Pub. Date: Nov. 2, 2023

(54) Anti-limescale composition

(71) Applicant: Politecnico di Milano, Milano MI (IT)

(72) Inventors: Andrea MELE, Milano MI (IT); Monica FERRO, Milano MI (IT); Greta COLOMBO DUGONI, Milano MI (IT)

(21) Appl. No.: 17/926,499

(22) PCT Filed: May 20, 2021
(86) PCT No.: PCT/IB2021/054371

§ 371 Date: Nov. 18, 2022

(30) Foreign Application Priority Data
May 22, 2020 (IT) 102020000012028

(51) Int. Cl. C11D 7/32; C11D 11/00; C11D 7/50; C11D 7/24

(52) U.S. Cl. CPC C11D 7/5013; C11D 7/245; C11D 7/3254; C11D 11/0023; C02F 5/12

(57) ABSTRACT

Use as a decalcifying and descaling remover of a composition comprising:
a) a first solvent selected from:
   a1) a eutectic solvent consisting of a hydrogen bond acceptor and of a hydrogen bond donor,
   a2) an ionic liquid or
   a3) a mixture of said eutectic solvent and said ionic liquid;
   optionally associated with a second solvent b) selected from at least a lower alcohol, water or mixtures thereof, wherein
in the first eutectic solvent a1) the hydrogen bond acceptor and the hydrogen bond donor are halogen-free.

### DESCRIPTION

### Field of the Invention

The present invention relates to a decalcifying and anti-limescale composition.

### State of the Art

Limescale is the most common insoluble deposit that builds up on surfaces that come into contact with water and in heat exchangers, such as boilers, heating systems and household appliances. Limescale, as it is mainly made up of calcium carbonate, is a problem especially in areas with hard mains water. In particular, limescale can build deposits in the shower and on bathroom and kitchen surfaces, cause clogged taps and problems with household appliances such as washing machines and dishwashers.

In addition, limescale at industrial level can cause thermal efficiency problems by clogging pipes and forming deposits in boilers and heat exchangers.

It is known to tackle limescale problem with two different strategies: using products that prevent limescale build-up or periodically using products to remove limescale.

Known softeners are products used to prevent the limescale build-up. The most common softeners are based on chelating agents that “capture” the calcium ions (and other metal ions) and thus prevent the formation of insoluble salts. Currently, adsorbing and complexing agents such as zeolites and polycarboxylates are used.

On the other hand, as regards the decalcifying agents used for limescale removal, there are numerous products on the market. The most common ones are based on a weak acid (acetic, citric, formic, lactic acid...) formulated with surfactants and additives such as scents (limonene, cinnamal).

However, known decalcifying agents exhibit corrosive behaviour towards metals. In addition, due to their composition, known decalcifying agents are harmful and toxic to the user, e.g. causing skin damage and respiratory problems.

CN106866842 discloses a method for extracting chitin from shrimp shells comprising, as a first stage, the treatment of shrimp shell powder with a deep eutectic solvent selected from the following pairs; choline chloride/malic acid; choline chloride/citric acid, choline chloride/lactic acid.

US8901061 concerns a cleaning composition comprising a DES wherein the hydrogen bond donor is an organic acid or urea and the hydrogen bond acceptor is a choline salt and a surfactant.

This composition is used to remove dirt deriving from the deposits of cooked or burned food.

Chiappe C. et al.: “The possibility to obtain a new generation of ionic liquids starting from natural compounds”, 31 Dec. 2008 Green Chemical Reactions [Proceedings of the NATO Advanced Study Institute on New Organic Chemistry Reaction and Methodologies for Green Production Lecce Italy 29 October-10 Nov. 2006) Springer, Dordrecht, NL, pages 13-35 XP009144245, ISBN978-14020-8458-4 describe ionic liquids, e.g. choline citrate starting from natural compounds. In particular, combinations of the aforesaid ionic liquids and deep eutectic solvents, which are miscible in aqueous solvents, are described. Hoppe J. et al.: “Deep eutectic solvents based on choline cation - Physicochemical properties and influence on enzymatic reaction with [beta]-galactosidase”, Acta Paediatrica. Supplement, Elsevier BV, NL Vol.136, 6 Jun. 2019 pages 296-304, XP0875369, ISSN:0141-8130, DOI :10.1016/J.IJBIOMAC.2019.06.27 discloses an analysis of the physico-chemical properties of deep eutectic solvents (DES) and their uses as β-galactosidase-catalyzed reaction media. In particular, D4 (page 279, Table 1) describes a composition comprising an ionic liquid and a deep eutectic solvent, in which the hydrogen bond acceptor is choline acetate and the hydrogen bond donor is levulinic acid.

Shurui M..: “Amphiphilic nanostructure in choline carboxylate and amino acid ionic liquids and solutions”, Physical Chemistry Chemical Physics VOL.22, NO.6, January 2020, Pages 3490-3498,xp55768909,ISSN: 1463-9076, DOI: 10.1039/C9CP06752C study the analysis of the structures in the liquid state of six ionic liquids based on choline carboxylate/amino acid and mixtures thereof with water and various linear aliphatic alcohols by X-ray diffraction. In particular, an ionic liquid, miscible with ethanol, resulting from the reaction of choline hydroxide with lactic acid is disclosed.

### SUMMARY OF THE INVENTION

The applicant has found a composition that is capable of overcoming the drawbacks of the prior art so as to allow a complete removal of limescale from the surfaces while safeguarding the user’s health and reducing production costs.

In fact, the applicant has surprisingly found that a composition can be used as a decalcifying and descaling agent comprising:

a) a first solvent selected from:
a1) a eutectic solvent consisting of a hydrogen bond acceptor and of a hydrogen bond donor,
a2) an ionic liquid or
a3) a mixture of said eutectic solvent and said ionic liquid; or optionally associated with a second solvent b) selected from at least a lower alcohol, water or mixtures thereof, but characterised in that in the first eutectic solvent a1) the hydrogen bond acceptor and the hydrogen bond donor are halogen-free, the hydrogen bond acceptor is choline acetate and the hydrogen bond donor is selected from: glycolic acid, diglycolic acid, levulinic acid, lactic acid, imidazole, citric acid.

In fact, the applicant has found this composition to be simple, cheap and far less polluting than commercially available ones.

In fact, the composition of the invention is environmentally friendly and sustainable, as it contains no toxic or harmful components.

A further object of the invention are detergent compositions and cleaning products containing the composition object of the invention as a limescale agent.

### DESCRIPTION OF THE DRAWINGS

FIG. 1: It shows a first photo of the comparative example 1 between the composition according to the present invention and the commercial product Viakal®, characterized by the following composition: citric acid, formic acid, TNI<5% (C9 ethoxylate), benzyl salicylate, hexyl cinnamal (scent);

FIG. 2: It shows a second photo of the results of the comparative example 1;

FIG. 3: It shows a first photo of the comparative example 2 of step of depositing the product according to the present invention;

FIG. 4: It shows a second photo of the comparative example 2 of step of depositing the product according to the present invention;

FIG. 5: It shows a third photo of the results of the comparative example 2 of the product according to the present invention;

FIG. 6: It shows a first photo of the results of the comparative example 3 of the product according to the present invention;

FIG. 7: It shows photos of the comparative example 4 having the ASTM DIN 51360/2 standardised test among the compositions exemplified in the examples as object;

FIG. 8: It shows photos of the results of the comparative example 4 of the product according to the present invention;

FIG. 9: It shows an image related to the ASTM DIN 51360/2 standardised test of a conventional solvent corroding metal.

### DETAILED DESCRIPTION

For the purposes of the present invention, the definition “comprising” does not exclude the presence of further components/stages than those listed after this definition.

For the purposes of the present invention, the definition “consisting of” excludes the presence of further components/stages than those listed after that definition.

In the anti-limescale or decalcifying composition object of the invention, the first solvent may comprise a eutectic solvent, an ionic liquid or a combination of the eutectic solvent and the ionic liquid.

For the purposes of the present invention, eutectic solvents refer to the so-called deep eutectic solvents better known by the acronym DES. In other words, it is a combination of a hydrogen bond acceptor and a hydrogen bond donor. The hydrogen bond acceptor is choline acetate, while the hydrogen bond donor is selected from glycolic acid, diglycolic acid, levulinic acid, imidazole, lactic acid or citric acid, preferably it is selected from glycolic acid and citric acid, more preferably it is citric acid.

The eutectic solvent production reaction is preferably performed in a temperature range comprised between 25 and 100° C., more preferably between 40 and 90° C. even more preferably between 50 and 85° C. and according to a particularly preferred embodiment at 75° C.

According to the present invention the weight ratios between the components of the eutectic solvent, donor and acceptor of hydrogen bonds, preferably are comprised between 1:5 and 5:1, more preferably from 1:3 to 3:1, even more preferably from 1:2 to 2:1 and according to a particularly preferred solution said ratio is 1:1.

Advantageously, the use of the above-mentioned hydrogen bond acceptors and donors allows DES to be prepared by simple mixing of the two components at room temperature and pressure, reducing costs and production time.

For the purposes of the present invention, ionic liquid used as a solvent means the product resulting from the reaction of choline acetate or choline hydroxide with the conjugated bases of weak acids, selected from glycolic acid, diglycolic acid, lactic acid, levulinic acid, or citric acid.

Preferably, the ionic liquid is the product resulting from the reaction of choline hydroxide with one of the aforesaid conjugated bases of said weak organic acids selected from glycolic acid, diglycolic acid, lactic acid, levulinic acid or citric acid.

More preferably, the ionic liquid a2) is obtained using citric acid as the conjugated base.

The reaction for the production of the ionic liquid is preferably performed in a temperature range comprised between 20 and 90° C., more preferably between 70° C. even more preferably between 25 and 50° C. and according to a particularly preferred embodiment at 30° C.

According to the present invention the weight ratios between the components of the ionic liquid, choline acetate or choline hydroxide and the conjugated bases of weak acids, preferably are comprised between 1:5 and 5:1, more preferably from 1:3 to 3:1, even more preferably from 1:2 to 2:1 and according to a particularly preferred solution said ratio is 1:1.

DESs can in turn react to form the above-mentioned protic ionic liquid. Since the protic ionic liquid formation reaction is an equilibrium reaction, this explains the fact that the first solvent can be a mixture of DES and ionic liquid a3).

Preferably, the solvents a) in the composition object of the invention being halogen-free are easily disposed of industrially.

A particularly preferred composition is one in which the solvent a) is the solvent a1) or the ionic liquid.

For the purposes of the present invention, the solvent b) is selected from a lower alcohol, water or mixtures thereof. A lower alcohol is defined as a linear or branched C₂-C₆ alcohol, most preferably ethanol or isopropanol.

In accordance with another embodiment alternative to the previous one, the solvent is water.

In accordance with a further embodiment alternative to the previous one, the solvent b) is a mixture of a lower alcohol and water.

Preferably, the first solvent a) and the second solvent b), if any, are in volumetric ratios comprised between 10:1 and 1:1, preferably between 5:1 and 1:1, more preferably 3:1. Particularly preferred compositions are as follows
- 100% DES/IONIC LIQUID (v/v)
- 75% DES+ 25% ETHANOL/WATER (v/v)
- 50%DES+ 50% ETHANOL/WATER (v/v)
- 25%DES+ 75% ETHANOL/WATER (v/v)

Further preferred compositions comprise a combination of ionic liquid + water, ionic liquid + ethanol or ionic liquid + water + ethanol, and particularly preferred are also those shown in the examples.

The mixing between the first solvent a) and the second solvent b) is preferably performed in a temperature range comprised between 20 and 60° C., more preferably between 20 and 50° C. even more preferably between 20 and 40° C. and according to a particularly preferred embodiment at 25° C.

In addition, the mixing of a) with b) is preferably performed at atmospheric pressure. Preferably, the composition object of the present invention comprises at least one fragrance. In accordance with a preferred embodiment, the fragrance is limonene.

The composition comprising according to the present invention is used as a decalcifying agent for removing scale from a surface.

A further object of the present invention is a process for producing the above-described composition.

The process in question comprises the following steps:
A1. Providing the first solvent a) and optionally second solvent b) and optionally the fragrance c)
A2. mixing the components of stage A1.

Step A1. comprises alternatively the stages of preparing the eutectic solvent, the ionic liquid or the mixture of the eutectic solvent and of the ionic liquid.

For the preparation of the composition which is the object of the invention when in particular it contains the second solvent b) and the fragrance c) and the latter is limonene, the waste product of the process for extracting cellulose from citrus pulp described in the patent application filed at the same time as the filing of the present patent application may be used. This process B described in the patent application filed concurrently with this application comprises the following steps of:
B1. Mixing the biomass with a process solvent, which coincides with the solvent a) contained in the composition object of the invention, and precipitating the insoluble cellulosic residues;
B2. Separating the insoluble cellulosic residues from the mixture comprising biomass and process solvent;
B3. Separating the hemicellulose and the pectin from the process solvent mixture by adding a lower alcohol and water, i.e., the component b) of the composition of the invention to the mixture coming from step B2;
B4. Recovering the filtrate which is nothing more than a special composition that is the object of the invention.

### Example 1

In this example, choline hydroxide and glycolic acid have been mixed to give the ionic solvent choline glycolate. The molar ratio between the two components is 1:1. The solvent prepared here is used as it is for the action of limescale removal.

### Example 2

In this example, choline hydroxide and acetic acid have been mixed to give the ionic solvent choline acetate. The molar ratio between the two components is 1:1. The solvent prepared here is used as it is for the action of limescale removal.

### Example 3

In this example, choline hydroxide and citric acid have been mixed to give the ionic solvent choline citrate. The molar ratio between the two components is 1:1. The solvent prepared here is used as it is for the action of limescale removal.

### Example 4

In this example, choline hydroxide and glycolic acid have been mixed to give the ionic solvent choline glycolate. The molar ratio between the two components is 1:1. The solvent prepared here is mixed with water in a ratio 1:1 and used as it is for the action of limescale removal.

### Example 5

In this example, choline hydroxide and glycolic acid have been mixed to give the ionic solvent choline glycolate. The molar ratio between the two components is 1:1. The solvent prepared here is mixed with water in a volumetric ratio 1:1 and used as it is for the action of limescale removal.

### Example 6

In this example, choline hydroxide and acetic acid have been mixed to give the ionic solvent choline acetate. The molar ratio between the two components is 1:1. The solvent prepared here is mixed with water/ethanol (1:1) in a volumetric ratio 1:1 and used as it is for the action of limescale removal.

### Example 7

In this example, choline acetate and glycolic acid have been mixed to give DES choline acetate: glycolic acid. The molar ratio between the two components is 1:1. The solvent prepared here is mixed with a water/ethanol mixture (volumetric ratio 1:1) in a volumetric ratio 1:1 and used as it is for the action of limescale removal.

### Example 8

In this example, choline acetate and glycolic acid have been mixed to give DES choline acetate: glycolic acid. The molar ratio between the two components is 1:1. The solvent prepared here is used as it is for the action of limescale removal.

### Example 9

The solvent recovered from the citrus pulp biomass treatment process containing DES choline acetate: glycolic acid, ethanol, water in a volumetric ratio 1:1:1, is tested for scale removal.

### Example 10

The solvent recovered from the citrus pulp biomass treatment process containing the ionic liquid choline glycolate, ethanol, water in a volumetric ratio 1:1:1 is tested for scale removal.

Advantageously, the composition according to the present invention makes it possible to remove limescale from the surfaces more efficiently than known and currently marketed products, even when the composition is further diluted in water and/or ethanol.

### COMPARATIVE EXAMPLES

Preparation of the limescale layer on the slides.
a) a film of water is deposited on the entire surface of a slide;
b) the aqueous film is evaporated.

The aforesaid operating modalities are repeated three times.

At the end of this procedure, a limescale layer is obtained which is evenly distributed over almost the entire surface of the slide.

### Comparative Example 1

Product 1: commercially available (Viakal, P&G). Composition: citric acid, formic acid, TNI<5% (C9 ethoxylate), benzyl salicylate, hexyl cinnamal (scent).

Product 2: DES choline acetate: glycolic acid prepared like in example 7

Product 3: 50% DES choline acetate: glycolic acid prepared like in example 7 + 50% water (v/v)

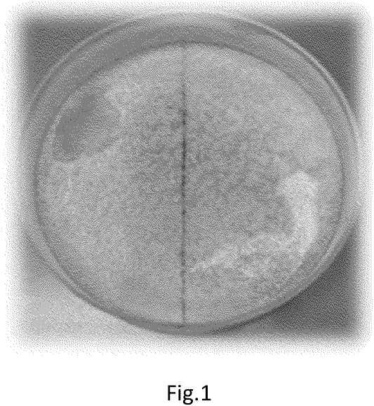

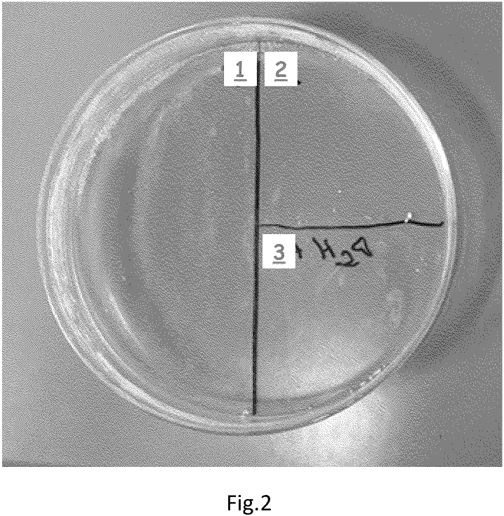

The commercial product is deposited on the portion identified with number 1. The same volumetric quantities of products 2 and 3 are deposited on the portions of the slide identified with 2 and 3, respectively. It is allowed to act for 5 minutes (FIG. 1). The products are wiped off with a dampened cloth. The products 2 and 3 perform better than the commercial product (FIG. 2).

### Comparative Example 2

Product 1:50% Ionic liquid choline citrate + 50% water (v/v)

Product 2: 50% Ionic liquid choline acetate + 50% ethanol (v/v)

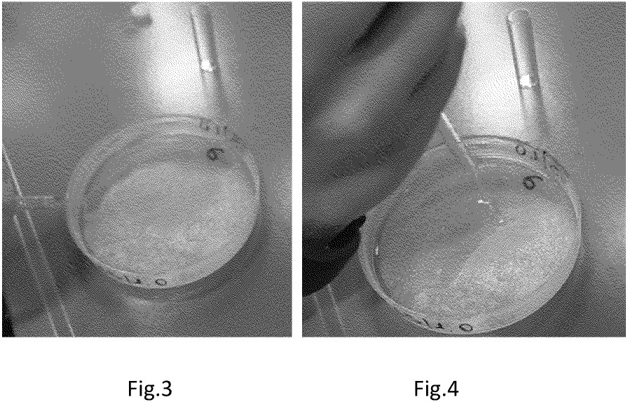

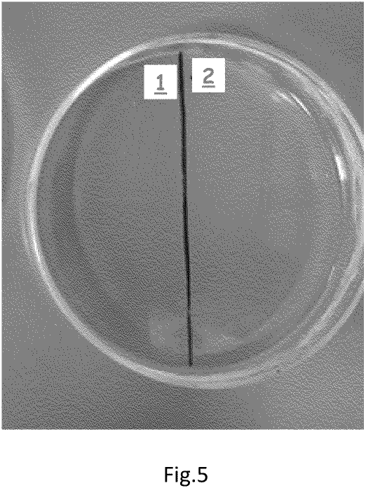

The product 1 is applied to the portion of the slide identified with number 1 and the product 2 is applied to the portion of the slide identified with number 2. (FIGS. 3 and 4).

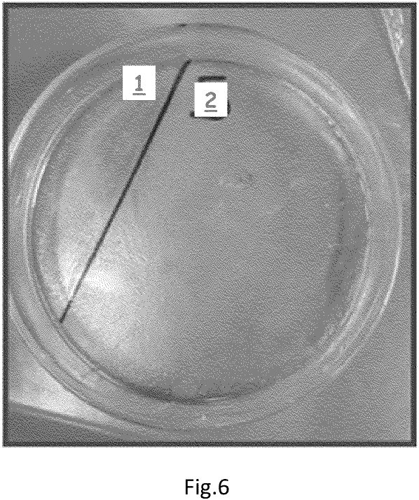

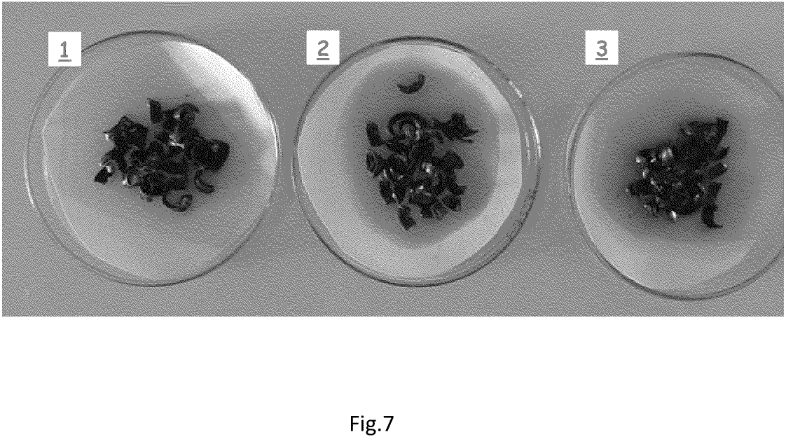

It is allowed to act for 5 minutes. Both products are wiped off with a dampened cloth. The product 1 and 2 are both found to have very good anti-limescale properties (FIG. 5).

### Comparative Example 3

Product 1: commercially available. Composition: citric acid, formic acid, TNI<5% (C9 ethoxylate), benzyl salicylate, hexyl cinnamal (scent).

Product 2: solvent recovered from the citrus pulp biomass treatment process containing the ionic liquid choline glycolate, ethanol, water in a volumetric ratio 1:1:1.

The product 1 is deposited on the portion of the slide identified with 1 and the product 2 on the portion of the slide 2. It is allowed to act for 5 minutes.

The products are wiped off with a dampened cloth.

The products 1 and 2 perform equally well (FIG. 5).

### Comparative Example 4

The commercial product, used as a sample benchmark, with the composition: citric acid, formic acid, TNI<5% (C9 ethoxylate), benzyl salicylate, hexyl cinnamal (scent), is corrosive to metals due to the presence of corrosive organic acids in the composition. The products proposed here have been tested against metal corrosion using the ASTM DIN 51360/2 standardised test.

Three different formulations are tested:
Product 1: Choline glycolate
Product 2: Choline acetate:glycolic acid
Product 3: Choline citrate + 50% water

2 g of Cast Iron Chips are deposited on a standard paper filter. The product (approx. 2 ml) is deposited on the chips. It is waited 2 hours (FIG. 7).

The chips are removed and the filter is checked for corrosion.

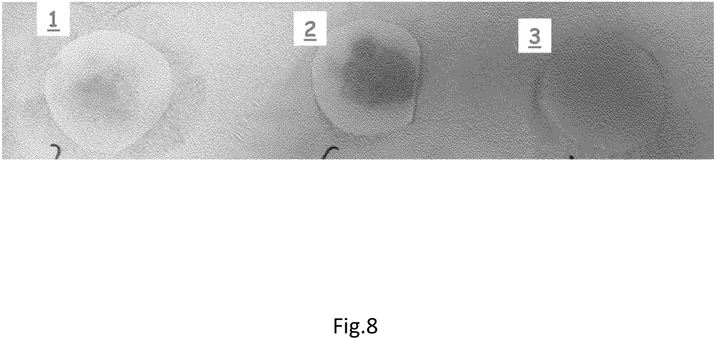

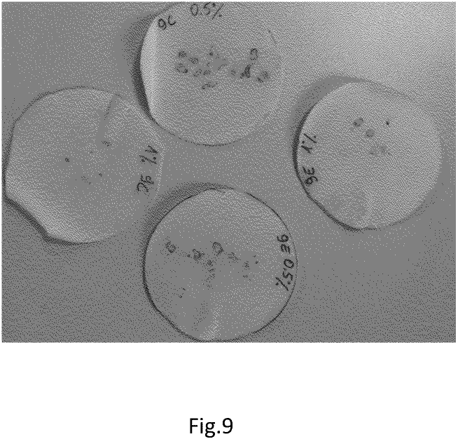

As can be seen from the image in FIG. 8, no corrosion is shown for the metals. In fact, as illustrated in FIG. 9 relating to an ASTM DIN 51360/2 standardised test on other compositions not object of the present invention, in the presence of corrosion of the metals after the removal of the metal chips, the formation of rust deposits is observed.

1-10. (canceled)

11. A method for decalcifying and removing limescale from a surface comprising applying to said surface a composition containing:
a) a first solvent selected from:
a1) a eutectic solvent consisting of a hydrogen bond acceptor and of a hydrogen bond donor,
a2) an ionic liquid
a3) a mixture of said eutectic solvent and said ionic liquid;
optionally associated with a second solvent b) selected from at least a lower alcohol, water or mixtures thereof wherein
in the eutectic solvent a1),the hydrogen bond acceptor and the hydrogen bond donor are halogen-free, the hydrogen bond acceptor is choline acetate, and the hydrogen bond donor is selected from: glycolic acid, diglycolic acid, levulinic acid, lactic acid, imidazole, citric acid.

12. The method according to claim 11, wherein the hydrogen bond donor is selected from glycolic acid and citric acid.

13. The method according to claim 11, wherein the ionic liquid is the product resulting from the reaction of choline acetate or choline hydroxide with conjugated bases of weak acids, selected from glycolic acid, diglycolic acid, levulinic acid, lactic acid, or citric acid.

14. The method according to claim 13, wherein the ionic liquid is the product resulting from the reaction of choline hydroxide with one of the conjugated bases of weak organic acids selected from glycolic acid, diglycolic acid, lactic acid, levulinic acid or citric acid.

15. The method according to claim 11, wherein said ionic liquid a2) is obtained starting from the conjugated base of citric acid.

16. The method according to claim 11, wherein in said solvent b) the lower alcohol is ethanol or isopropanol.

17. The method according to claim 11, wherein said composition contains a fragrance.

18. The method according to claim 17, wherein said fragrance is limonene.

19. The method according to claim 11, wherein the solvent a) is the ionic liquid a2).

20. The method according to claim 11, wherein said composition is comprised in detergent compositions and household cleaning products.
